(19) United States
(12) Patent Application Publication
(10) Pub. No.: US 2026/0316627 A1
(43) Pub. Date: Oct. 15, 2026

(54) DUAL BATTERY POWERED SYSTEMS AND METHODS

(71) Applicant: Luxor Workspaces, LLC, Birmingham, AL (US)

(72) Inventor: Zachariah Mundy, Libertyville, IL (US)

(73) Assignee: Luxor Workspaces, LLC, Birmingham, AL (US)

(21) Appl. No.: 19/641,789

(22) Filed: Apr. 8, 2026

Related U.S. Application Data
(60) Provisional application No. 63/787,627, filed on Apr. 11, 2025.

(51) Int. Cl. B60L 58/18; B60L 3/00; B60L 50/60; B60L 53/80; B60L 58/12; B60L 58/16; B62B 5/00

(52) U.S. Cl. CPC B60L 58/18; B60L 3/0046; B60L 50/66; B60L 53/80; B60L 58/12; B60L 58/16; B62B 5/0053; B60L 2210/10; B60L 2250/16

(57) ABSTRACT

A mobile power system for a movable workstation is disclosed that provides uninterrupted and flexible power delivery in demanding environments, such as healthcare settings. The system includes a cart-mounted power architecture having first and second removable batteries, associated battery management systems, and a controller configured to automatically select between the batteries for supplying power. A power switching device enables seamless transition between batteries to support replacement without interruption of load power.

### CROSS-REFERENCE TO RELATED APPLICATIONS

This application claims the benefit of U.S. Provisional Patent Application No. 63/787,627, filed Apr. 11, 2025, which is incorporated by reference herein in its entirety.

### FIELD OF THE DISCLOSURE

The present disclosure generally relates to a mobile battery powered system, and more particularly, to a mobile battery powered system having dual batteries capable of maintaining power when one battery has a low or depleted power level.

### BACKGROUND OF THE DISCLOSURE

Mobile workstations and powered carts are widely used across various industries, including, for example, healthcare environments to support clinical workflows, electronic medical medication administration, and various point‑of‑care activities. Conventional powered carts frequently rely on either tethered power cords for continuous operation or integrated battery systems that provide only limited runtime. With corded systems, the requirement to maintain a physical connection to a wall outlet restricts the mobility of the cart, inhibits flexible use, and can pose safety hazards due to cable management challenges.

Battery‑powered alternatives attempt to resolve mobility constraints; however, existing implementations often require the battery to be removed from the cart for recharging or rely on fixed internal power packs that cannot be exchanged during use. These limitations result in unavoidable downtime when the battery is depleted. In many cases, the user must wait for a battery to charge, interrupt ongoing workflows, or switch to a backup workstation. In addition to power‑related challenges, traditional carts may lack ergonomic adjustability, adequate storage integration, or durable mobility hardware. These deficiencies can reduce efficiency and limit the effective deployment of mobile workstations in fast‑paced settings.

Accordingly, there remains a need in the art for a mobile workstation power system that provides uninterrupted power delivery, improved mobility, and enhanced ergonomic and storage features without the restrictions of tethered power cords or the downtime associated with traditional rechargeable battery systems.

### SUMMARY OF THE DISCLOSURE

The problems expounded above, as well as others, are addressed by the following inventions, although it is to be understood that not every embodiment of the inventions described herein will address each of the problems described above.

In some embodiments, a mobile power system is provided, the mobile power system including a movable cart having a base; a first battery and a second battery removably coupled to the base; a first battery management system configured to monitor a power level of the first battery and a second battery management system configured to monitor a power level of the second battery; a controller in communication with the first battery management system and the second battery management system and configured to receive the power levels therefrom; a switch operable by the controller to selectively couple at least one of the first battery or the second battery to a power bus; and wherein, based at least in part on the power levels received from the first and second battery management systems, the controller is configured to control which of the first and second batteries supplies power to the power bus and to enable uninterrupted operation of the mobile power system during removal or replacement of one of the batteries.

In one embodiment, the controller is configured to cause the switch to transition power draw from the first battery to the second battery when the power level of the first battery falls below a first threshold. In another embodiment, the mobile power system further includes a DC-DC converter coupled between each of the first battery and the second battery and the power bus. In still another embodiment, the mobile power system may further include an inverter coupled to the power bus, wherein the inverter is configured to provide AC power to at least one output port. In yet another embodiment, the mobile power system may further include an external power source connector configured to receive power from an external AC source. For instance, the mobile power system may include at least one charger configured to charge at least one of the first or second batteries while the system is powered by the external AC source. In still another embodiment, each of the first battery and the second battery includes an indicator configured to display at least one of charge state, charging status, or fault status. In another embodiment, the mobile power system includes a display operatively connected to the controller and configured to display battery status information.

In further embodiments, a mobile power system is provided, the mobile power system including a movable cart having a base; a battery housing attached to the base and defining a first receiving space and a second receiving space; a first connector configured to be coupled with a first battery positioned within the first receiving space; a second connector configured to be coupled with a second battery positioned within the second receiving space; a switch operatively connected to the first connector and the second connector; a controller configured to be communicatively coupled with the switch, the controller including instructions stored in memory which, when executed by the controller, cause the controller to: communicate with the switch to draw power from the first battery via the first connector; determine whether a power level of the first battery is below a predetermined power level; and communicate with the switch to draw power from the second battery in response to determining that the power level of the first battery is below the predetermined power level.

In one embodiment, the instructions, when executed by the controller, cause the controller to: communicate with the switch to stop drawing power from the first battery in response to determining that the power level of the first battery is below the predetermined power level. In another embodiment, the instructions, when executed by the controller, cause the controller to: determine whether a power level of the second battery is below a predetermined power level; and communicate with the switch to draw power from the first battery in response to determining that the power level of the second battery is below the predetermined power level. In still another embodiment, the instructions, when executed by the controller, cause the controller to: communicate with the switch to stop drawing power from the second battery in response to determining that the power level of the second battery is below the predetermined power level. In yet another embodiment, the battery housing is positioned such that a center of gravity of the movable cart is proximate the base of the cart. In still another embodiment, the battery housing includes a first retention clip configured to retain the first battery within the battery housing during operation and a second retention clip configured to retain the second battery within the battery housing during operation. In yet another embodiment, each of the first retention clip and the second retention clip includes one or more protrusions configured to align with and be received by corresponding slots formed in each of the first and second receiving spaces.

In still further embodiments, a method of providing uninterrupted power to a mobile workstation including a first battery and a second battery, a controller in communication with the first battery and the second battery, and a switch operable by the controller to selectively couple at least one of the first battery or the second battery to a power bus is provided, the method including monitoring, by the controller, power data from the first battery and the second battery; supplying power from the first battery to the power bus; detecting that the power level of the first battery falls below a threshold; automatically switching, via the switch, power from the first battery to the second battery; and maintaining power to the mobile workstation during the switching.

In one embodiment, the method may include removing the first battery from the mobile workstation while the second battery supplies power. In another embodiment, the method may include charging one of the batteries using an external charging system while the other battery remains installed. In still another embodiment, the method may include displaying battery status information on a display coupled to the mobile workstation. In yet another embodiment, the battery status information includes at least one of voltage, current, temperature, state of charge, or state of health.

### BRIEF DESCRIPTION OF THE DRAWINGS

The following is a description of the figures in the accompanying drawings. The figures are not necessarily to scale, and certain features and certain view of the figures may be shown exaggerated in scale or in schematic in the interest of clarity and conciseness.

FIG. 1A is a perspective view of a battery-powered mobile workstation in accordance with one embodiment of the present disclosure.

FIG. 1B is a perspective view of a battery-powered mobile workstation in accordance with another embodiment of the present disclosure.

FIG. 1C is a perspective view of a battery-powered mobile workstation in accordance with still another embodiment of the present disclosure.

FIG. 1D is a side view of an electronics housing according to one embodiment of the present disclosure.

FIG. 2A is an enlarged view of a base of a battery-powered mobile workstation with first and second batteries engaged therein in accordance with some embodiments of the present disclosure.

FIG. 2B is an enlarged view of the base of the battery-powered mobile workstation of FIG. 2A with the first and second batteries disengaged in accordance with some embodiments of the present disclosure.

FIG. 3A is a top perspective view of a battery housing in accordance with one embodiment of the present disclosure.

FIG. 3B is a top perspective view of the battery housing with first and second batteries engaged therein in accordance with some embodiments of the present disclosure.

FIG. 4A is a front perspective view of a battery retaining mechanism attached to the battery housing in accordance with one embodiment of the present disclosure.

FIG. 4B is a bottom perspective view of the battery retaining mechanism attached to the battery housing in accordance with one embodiment of the present disclosure.

FIG. 4C is a front perspective view of the battery retaining mechanism in accordance with one embodiment of the present disclosure.

FIG. 5 is a side profile view of a battery housing connected to an external power source in accordance with some embodiments of the present disclosure.

FIG. 6 is a perspective view of an exemplary battery for use with the battery-powered mobile workstation in accordance with some embodiments of the present disclosure.

FIG. 7 is a schematic diagram of a power system configured to selectively control power delivery from the first and second batteries in accordance with certain embodiments of the present disclosure.

FIG. 8 is a schematic diagram of an external charge system for a battery for use with the battery-powered mobile workstation in accordance with some embodiments of the present disclosure.

FIG. 9 is a schematic diagram of a power system for the battery-powered mobile workstation in accordance with some embodiments of the present disclosure.

FIG. 10 is a block diagram of the controller of FIG. 9 in accordance with some embodiments of the present disclosure.

FIG. 11 is a schematic diagram of electronic components related to the battery-powered mobile workstation in accordance with some embodiments of the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well (i.e., at least one of whatever the article modifies), unless the context clearly indicates otherwise.

The terms “first,” “second,” “third,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Spatially relative terms, such as “above,” “under,” “below,” “lower,” “over,” “upper,” “right,” “left,” “vertical,” “horizontal,” “rear,” “front,” and the like, may be used herein for ease of description to describe one element or feature’s relationship to another when the apparatus is right side up as shown in the accompanying drawings.

The term “substantially” allows for deviations from the descriptor that do not negatively impact the intended purpose. Descriptive terms are understood to be modified by the term “substantially” even if the word “substantially” is not explicitly recited.

For purposes of this disclosure, the term “coupled” (in all its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is to be understood that any given element of the disclosed embodiments of the invention may be embodied in a single structure, a single step, a single substance, or the like. Similarly, a given element of the disclosed embodiment may be embodied in multiple structures, steps, substances, or the like.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term, “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The present disclosure provides a mobile power system featuring single or dual swappable battery modules, robust mobility components, ergonomic adjustability, and integrated storage solutions. This configuration enables continuous, uninterrupted power to all onboard components while allowing batteries to be exchanged without shutting down devices or removing the workstation from service. The system described herein provides a reliable, ready‑to‑use power platform that enhances workflow efficiency and mobility, while eliminating the constraints imposed by traditional corded or fixed‑battery systems.

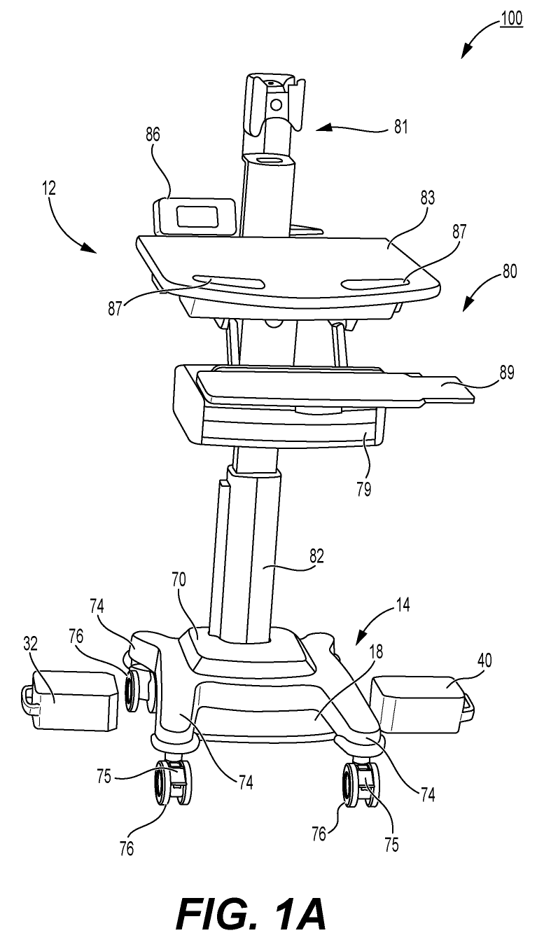

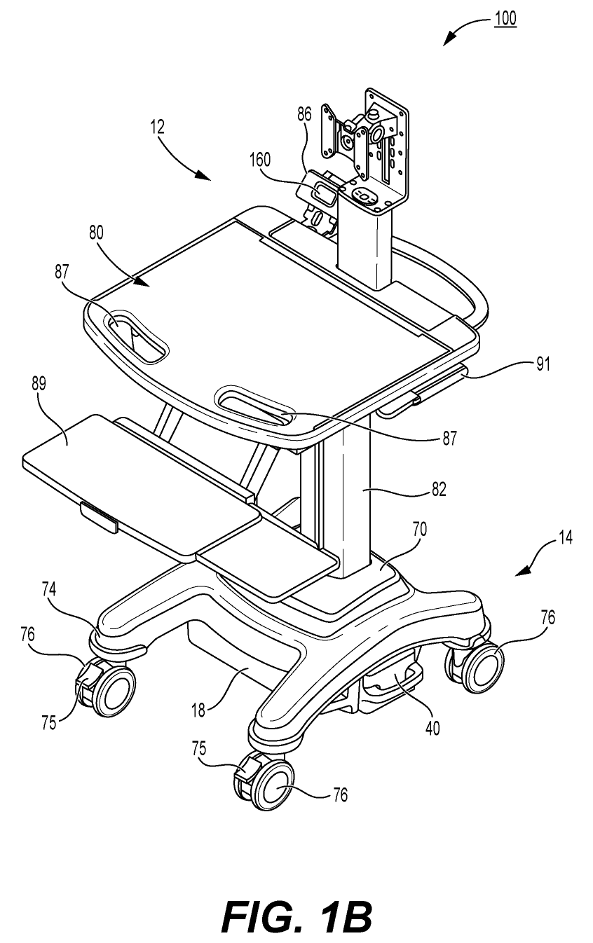

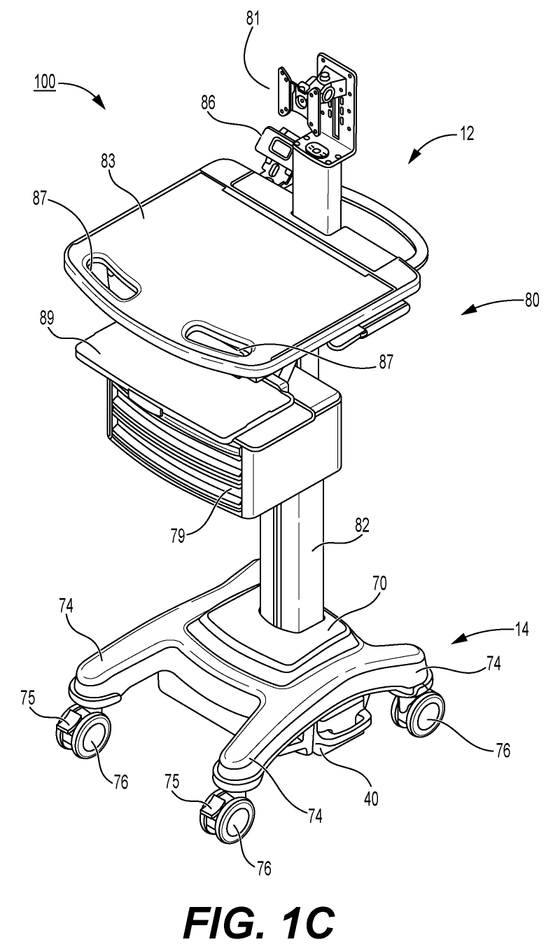

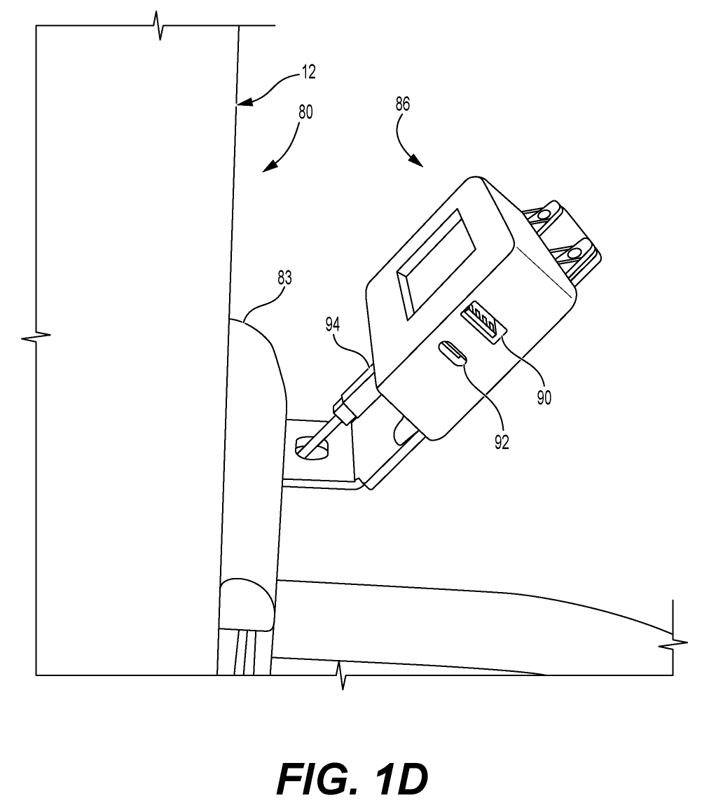

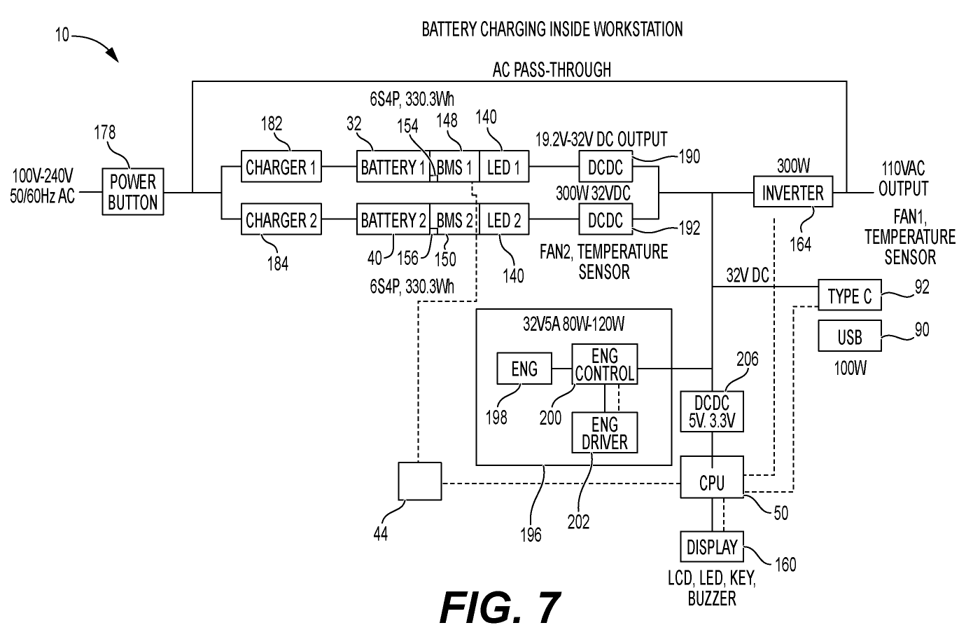

Referring to FIGS. 1A-1C, a mobile workstation 100 in accordance with the present disclosure is shown. The mobile workstation 100 includes a power system 10 (shown in FIGS. 7, 9, and 10) for providing and controlling power to components of a cart 12. The cart 12 may include a base 14 having a battery housing 18 positioned proximate thereto. The battery housing 18 may define a first receiving space 22 and a second receiving space 24. A first connector 28 may be configured to be coupled with a first battery 32 when the first battery 32 is positioned within the first receiving space 22, and a second connector 36 may be configured to be coupled with a second battery 40 when the second battery 40 is positioned within the second receiving space 24. A switch 44 may be electrically coupled with the first connector 28 and/or the second connector 36. A controller 50 including instructions 54 stored in memory 58 may be configured to be communicatively coupled with the switch 44 to selectively draw power from one or both of the first and second batteries 32, 40 based on power levels of the first and second batteries 32, 40.

The cart 12 is shown including the power system 10 for controlling power from the first and second batteries 32, 40. While the power system 10 herein is shown and described for use with the cart 12 as shown in FIGS. 1, it will be understood that the power system 10 may be used in other configurations where battery power is required. The base 14 of the cart 12 may include a central portion 70 and one or more extensions 74 extending outward from the central portion 70 of the base 14. In various examples, the base 14 may include a wheel 76 positioned on an outer end of each extension 74. In other words, each extension 74 may be operably coupled with a respective wheel 76 at an outer end of the extension 74. In one embodiment, each wheel 76 may be a caster having low‑rolling‑resistance treads and a locking mechanism. For example, each wheel 76 may be a caster having a lock brake 75 to ensure smooth, stable, and secure workstation transport. In another embodiment, the wheels 76 may be power wheels configured to be controlled by a controller (e.g., the controller 50). The cart 12 may be any form of cart such as, for example, a medical cart, a warehouse cart, or a TV cart.

The cart 12 may further include an upper portion 80 configured to support or couple with one or more devices such as, for example, a computer, displays, user inputs and outputs, printers, etc. For example, in one embodiment, the upper portion 80 may include an adjustable mount 81 for attaching a computer, display, monitor, or other electronic device. The upper portion 80 may also include a work surface 83. The work surface 83 may include one or more handles 87 for transporting the cart 12. In further embodiments, the cart 12 includes a slidable tray 89 positioned below the work surface 83 for storing and utilizing, for instance, a keyboard, mouse, or other similar device. In still further embodiments, the cart 12 may include one or more storage compartments 79 attached thereto.

The upper portion 80 may include features to assist in using the devices or to assist in moving or adjusting the cart 12, such as handles, user‑interface controls, or adjustment actuators. The upper portion 80 may be coupled to a vertical support 82 extending between the upper portion 80 and the base 14, with the vertical support 82 operably coupled to the base 14 to provide structural support and vertical movement. An ergonomic height‑adjustment mechanism may be coupled to the cart 12 and configured to adjust the elevation of the work surface 83 between a first position (for example, a seated position) and a second position (for example, a standing position). In one embodiment, the height-adjustment mechanism may include a motorized lift. In this embodiment, the vertical support 82 may be a powered lifting column configured to be controlled by a controller (e.g., the controller 50). In another embodiment, the height-adjustment mechanism may include a gas‑spring column or a pneumatic lift. In this embodiment, the vertical support 82 may include a pneumatic actuator configured to provide vertical movement through controlled extension and retraction in response to user input. The pneumatic lift may include an internal pressurized gas chamber and a valve mechanism operable by a handle 91, such that selectively actuating the valve permits upward or downward movement of the upper portion 80 under load. In some embodiments, the pneumatic lift may further include damping elements to regulate movement speed, mechanical stops defining minimum and maximum height positions, and a locking mechanism configured to maintain the work surface 83 at a selected elevation when the valve is not actuated

As best shown in FIG. 1D, an electronics housing 86 may be coupled to the upper portion 80 of the cart 12. For example, the electronics housing 86 may be positioned on, within, or proximate to the work surface 83 of the upper portion 80. The electronics housing 86 may define an internal space configured to receive and support one or more output ports. By way of non‑limiting example, the one or more output ports may include a USB‑A port 90, a USB‑C port 92, a single AC power outlet 94, a multi‑outlet electric power strip, or combinations thereof, as well as other power or data interfaces. The electronics housing 86 may be configured to fully enclose the one or more output ports 90, 92, 94 or to partially enclose the one or more output ports such that the ports remain accessible to a user. In some embodiments, the one or more output ports 90, 92, 94 may be provided without the electronics housing 86. For example, AC power may be delivered to a multi‑outlet electric strip positioned within an enclosure mounted beneath the upper portion 80 of the cart 12 or at another location on the cart 12. The electronics housing 86 may further include a display 93 configured to present indicia associated with the electronics housing, such as operating status, power availability, or status of one or more of the output ports 90, 92, 94.

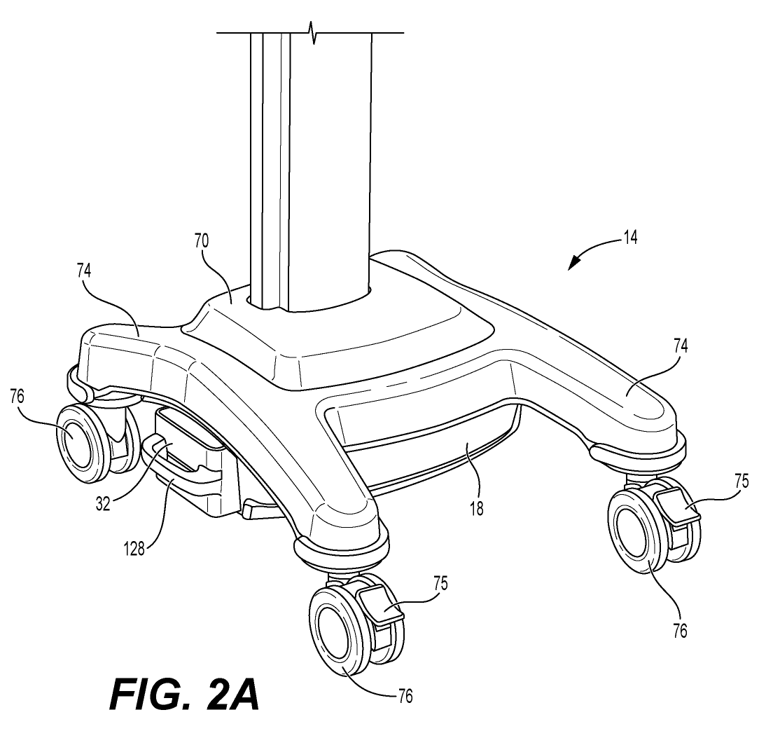

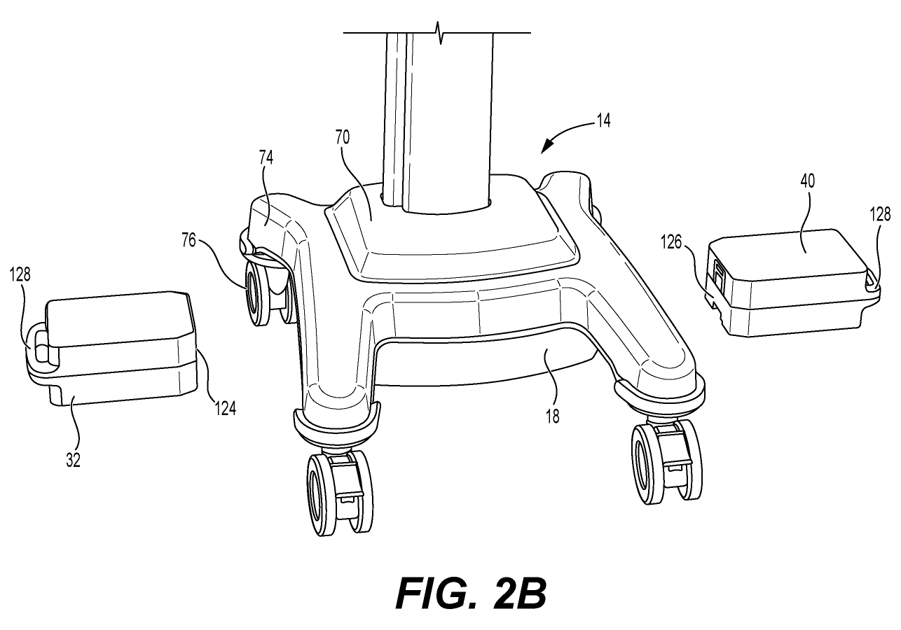

Referring now to FIGS. 2A and 2B, the battery housing 18 may be coupled to an underside of the base 14, for example, an underside of the central portion 70 of the base 14. The battery housing 18 may be configured to receive one or more removable batteries, such as the first battery 32 and/or the second battery 40, each of which may be selectively inserted into or removed from the battery housing 18 while the cart 12 remains in use. As shown, the battery housing 18 may define multiple battery bays oriented to provide accessibility from opposing sides of the housing 18, thereby facilitating hot‑swappable operation without requiring tilting or inversion of the cart 12.

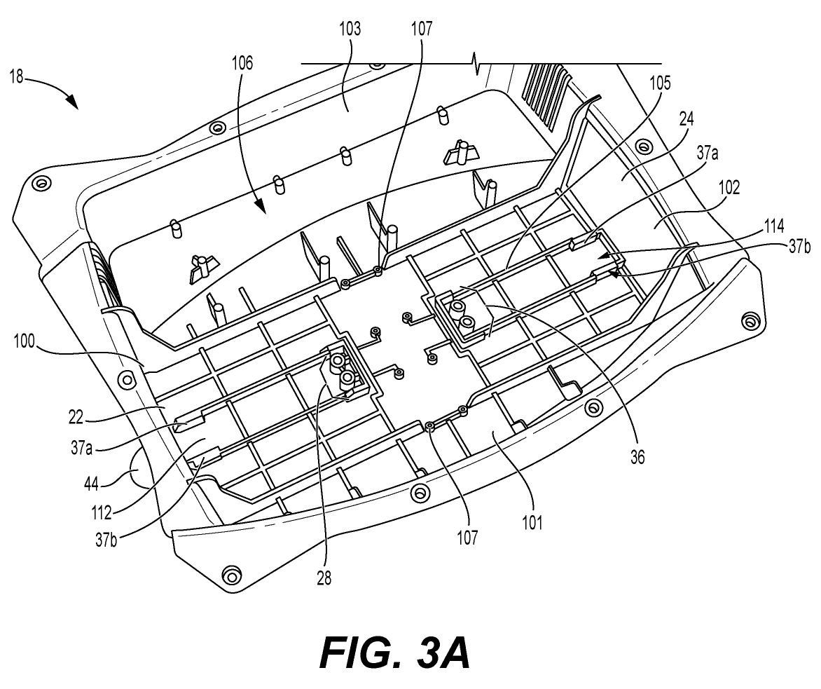

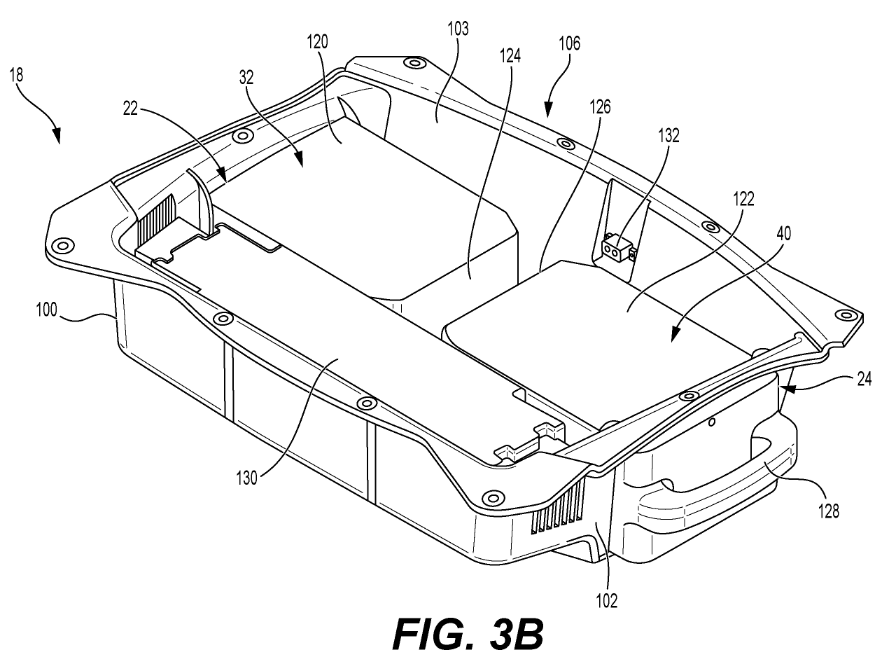

As best shown in FIGS. 3A and 3B, the battery housing 18 includes a generally enclosed body defining an internal cavity 106 configured to receive and support the first battery 32 and/or the second battery 40. The internal cavity 106 may be configured to accommodate internal electrical components and facilitate insertion and removal of the batteries 32, 40. The battery housing 18 may include a substantially planar base 101 and an upstanding perimeter wall 103 that together form the cavity 106. In some embodiments, the interior cavity 106 includes a network of reinforcing ribs 105 extending across the base 101 and along interior surfaces of the perimeter wall 103. These ribs 105 subdivide the interior cavity 106 into structural sections and increase rigidity of the housing 18 while limiting deflection under load. As illustrated, a plurality of mounting features 107 may be integrally formed within the interior cavity 106, for example, on the base 101. These mounting features 107 may include bosses, posts, or standoffs configured to receive fasteners or to support internal components, such as electrical connectors, printed circuit boards, power management circuitry, or retention brackets. The mounting features 107 may be spaced apart and aligned to provide stable attachment points while maintaining clearance for airflow or wiring.

The battery housing 18 includes first and second opposing end regions 100, 102, each defining a respective receiving space 22, 24. In other words, the first end region 100 may define the first receiving space 22, and the second end region 102 may define the second receiving space 24. However, it is contemplated that the first and second receiving spaces 22, 24 may be defined by any portion of the housing 18, including but not limited to a forward wall, a rear wall, a top wall, or a bottom wall without departing from the scope of the present disclosure.

In one embodiment, the interior cavity 106 is in communication with the first and second receiving spaces 22, 24. The cavity 106 may be at least partially defined by the base 101 of the battery housing 18. As illustrated in FIG. 3A, the base 101 may include a first guide 112 proximate the first receiving space 22 and configured to guide insertion of the first battery 32 into the first receiving space 22. The base 101 may include a second guide 114 proximate the second receiving space 24 and configured to guide insertion of the second battery 40 into the second receiving space 24. The guides 112, 114 may assist in aligning the respective batteries with corresponding electrical connectors and in maintaining proper positioning of the batteries during installation and removal. In some embodiments, the battery housing 18 may further include electrical connectors 28, 36 positioned to engage corresponding terminals of each of the first battery 32 and/or the second battery 40 upon insertion.

In certain embodiments, the cooperation between the guides 112, 114, the cavity 106, and the electrical connectors 28, 36 may enable hot‑swap operation of the batteries. For example, each receiving space 22, 24 may be configured to permit removal of one battery while the remaining battery continues to supply power to the cart 12, thereby enabling uninterrupted power delivery. The guides 112, 114 may further assist in ensuring rapid and reliable re‑insertion of a replacement battery, minimizing alignment errors and facilitating seamless transition between power sources during the hot‑swap process.

As shown in FIG. 3B, each of the first battery 32 and the second battery 40 includes a body 120, 122, respectively. The first battery 32 includes a first connecting end 124, and the second battery 40 includes a second connecting end 126. For example, each of the respective connecting ends 124, 126 are configured to engage with a respective electrical connector 28, 36 positioned within the battery housing 18. The first and second connectors 28, 36 may be communicatively coupled with a controller, as discussed in more detail below. In various examples, each of the electrical connectors 28, 36 may be a socket connector or a prong connector; however, it will be understood that the electrical connectors 28, 36 may be any electrical connector configured to electrically couple a battery with a controller without departing from the scope of the present disclosure. In another embodiment, the battery housing 18 may include an external power source connector 132 mounted therein. The power source connector 132 may be configured to be coupled with an external power source.

In further embodiments, the first and second batteries 32, 40 may further be electrically coupled with the one or more power outputs 90, 92, 94 positioned within the electronics housing 86 such that, when the first and second batteries 32, 40 are coupled with the first and second connectors 28, 36, the first and second batteries 32, 40 provide power to the one or more power outputs 90, 92, 94.

In some embodiments, the battery housing 18 may further include a compartment 130 configured to house one or more components of the power system 10. The compartment 130 may be defined within the battery housing 18 and positioned to be structurally protected by the base 14 of the cart 12. The compartment 130 may be configured to receive and support power‑related components such as power converters, control circuitry, connectors, wiring, and portions of the inverter or charging circuitry associated with the power system 10. The compartment 130 may thereby facilitate compact integration of the power system components within the battery housing 18 while maintaining accessibility for service and protecting the components from environmental exposure and mechanical impact during operation of the cart 12.

In some embodiments, the first and second batteries 32, 40 may each include a handle 128 to aid in removal, insertion, and transport of the respective battery 32, 40. Placement of the battery housing 18 and the first and second batteries 32, 40 proximate the base 14 of the cart 12 is configured to lower the center of gravity of the cart 12. This adjustment to the center of gravity may result in increased stability for the cart 12.

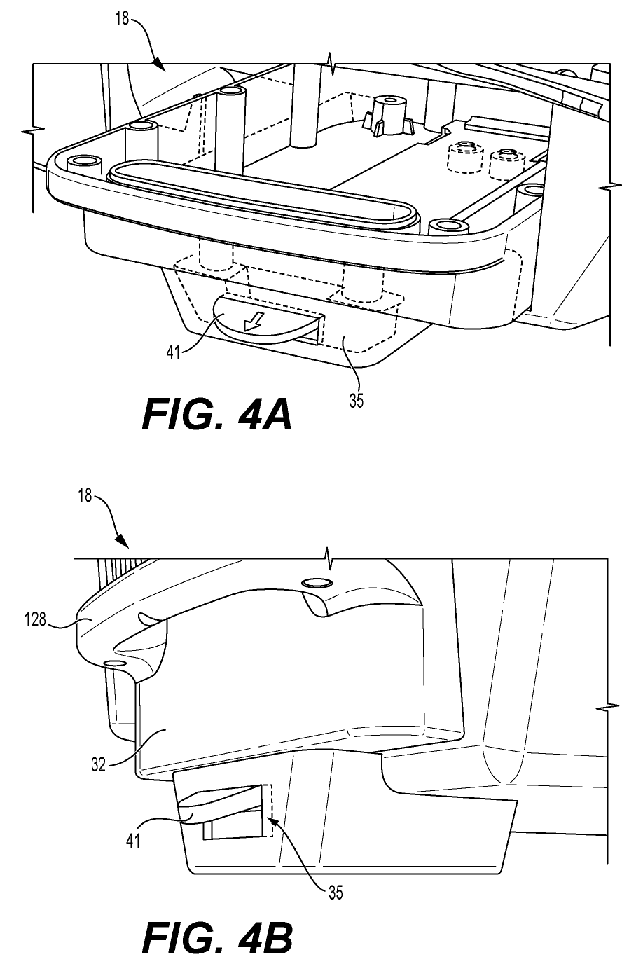

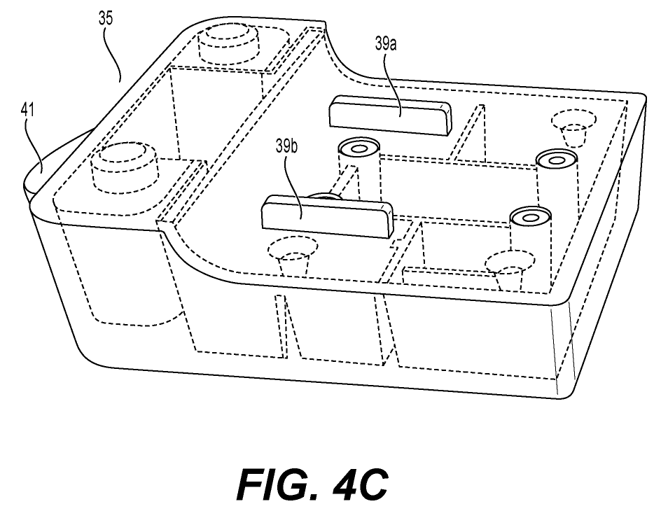

FIGS. 4A-4C illustrate a retaining mechanism for securing each of the batteries 32, 40 while in use. As shown in FIGS. 4A and 4B, each receiving space 22, 24 of the battery housing 18 may further include a retention clip 35 configured to secure the corresponding removable battery 32 or 40 in a retained position during use. The retention clip 35 is provided on each side of the battery housing 18 adjacent a respective receiving space 22, 24, such that each battery is independently retained. In certain embodiments, the retention clip 35 may be formed from a polymeric material, spring steel, or another resilient material to provide repeated engagement and disengagement over multiple battery insertion and removal cycles.

The retention clip 35 may be formed as a separate component from the battery housing 18 and may be coupled to the housing 18 through cooperation with engagement features of the housing 18. For example, as best shown in FIG. 4C, the retention clip 35 may include protrusions 39a, 39b configured to align with and be received by corresponding slots 37a, 37b formed in each of the receiving spaces 22, 24 of the battery housing 18. As shown, the protrusions 39a, 39b of the retention clip 35 may extend into the slots 37a, 37b in the base 101 of the battery housing 18, while additional portions of the clip 35 engage pre-existing slots or recesses, thereby ensuring proper orientation and positional stability of the clip 35 relative to the housing 18.

In some embodiments, the retention clip 35 may include a resilient or flexible portion 41 configured to apply a biasing force against an exterior surface of the battery 32, 40 when the battery is fully inserted into the receiving space 22, 24. This biasing force may act to prevent unintended withdrawal, rattling, or vertical movement of the battery 32, 40 during transport of the cart. The clip 35 may be configured such that intentional removal of the battery 32, 40 is permitted by applying a manual force sufficient to overcome the biasing force, thereby enabling tool-less battery removal while still maintaining secure retention during normal operation.

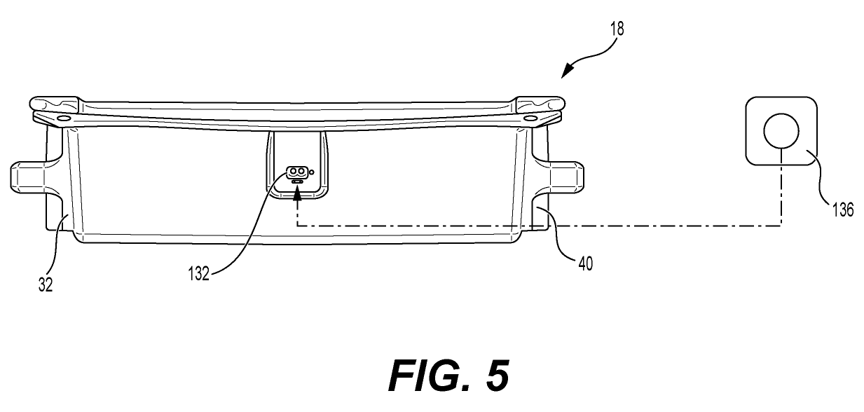

As shown in FIG. 5, the power source connector 132 may be configured to be coupled with an external power source 136. For example, the battery housing 18 and the power system 10 may be configured to connect to a wall outlet, power outlet, docking station, or other external power source via the power source connector 132. In some embodiments, the external power source 136 may be configured to provide charging power to the batteries 32, 40 while the batteries remain installed within the battery housing 18. The power system 10 may further be configured to manage charging parameters such as current, voltage, and charge state to safely and efficiently recharge the batteries.

In certain embodiments, the external power source 136 may be configured to supply operating power to the system 10 directly when coupled through the power source connector 132, thereby permitting the electronic components of the cart 12 to be powered by the external power source while the batteries 32, 40 are charged or maintained at a full or partial state of charge. In some embodiments, the external power source 136 may further serve as a backup or auxiliary power source in the event that the batteries 32, 40 are depleted, removed, or otherwise unavailable. In such embodiments, the power system 10 may be configured to automatically transition between battery power and external power without interruption to the powered components, thereby maintaining continuous operation of the cart during charging, battery replacement, or temporary loss of battery capacity.

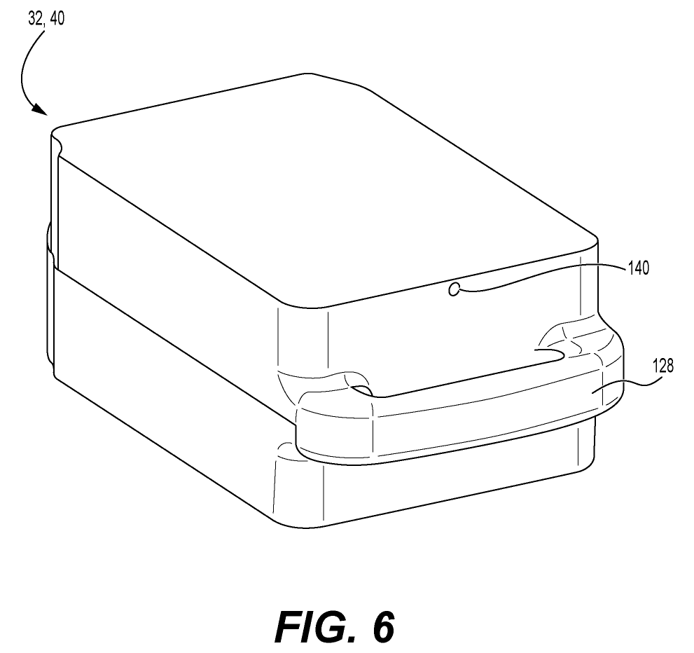

Referring now to FIG. 6, each of the first and second batteries 32, 40 may include an indicator light 140 disposed on an exterior portion of the respective battery and visible when the battery is installed in the battery housing 18. The indicator light 140 may be configured to be actuated by a respective battery management system 148, 150 (FIG. 7) to provide a visual indication of one or more operating properties of the battery, such as, by way of non‑limiting example, remaining power level, charging status, fault conditions, temperature status, or readiness for hot‑swap removal or insertion. In various examples, the indicator light 140 may be a light‑emitting diode (LED). However, it is contemplated that the indicator light 140 may be any kind of light or indicator configured to indicate a status of the respective battery 32, 40.

In some embodiments, the indicator light 140 may include a plurality of lights or a multi‑color indicator configured to illuminate in different colors, intensities, blinking patterns, or sequences to represent different battery conditions. For example, a first illumination pattern may indicate normal operation, a second illumination pattern may indicate active charging, and a third illumination pattern may indicate a low‑charge or fault condition. In further embodiments, the indicator light 140 may operate in coordination with the power system 10 to provide a user with immediate visual feedback regarding which battery is actively supplying power, which battery is being charged, or whether a battery may be safely removed during hot‑swap operation. The indicator light 140 may assist in reducing user error and improving the efficiency and reliability of battery replacement and power management during use of the cart.

Referring now to FIG. 7, an exemplary power system 10 for managing and controlling power supplied from the first and second batteries 32, 40 of the cart 12 is shown. The power system 10 may include a controller 50 in communication with a first battery management system 148 associated with the first battery 32, a second battery management system 150 associated with the second battery 40, and a switch 44 configured to selectively control power paths within the system. In some embodiments, each of the first and second battery management systems 148, 150 may include a respective sensor 154, 156 in communication with the controller 50. The battery management systems 148, 150 may be configured to monitor and determine one or more properties of the respective batteries 32, 40, such as voltage, current, temperature, state of charge, state of health, or fault conditions. The controller 50 may further be in communication with a display 160, an inverter 164, and one or more output ports 90, 92, 94.

As further shown in FIG. 7, the power system 10 may include an actuator 178, such as a power button or control input, configured to selectively provide power delivery to the system 10 from the external power source 136 (see FIG. 5). In some embodiments, the external power source 136 may be an AC power source. Power received from the external power source 136 may be routed directly to one or more AC power outlet output ports 94 and/or may be routed through one or more chargers 182, 184 to charge the first and second batteries 32, 40. In certain embodiments, the power system 10 may be operable without the actuator 178, such that connection of the external power source 136 automatically provides power to the system 10 without requiring user actuation.

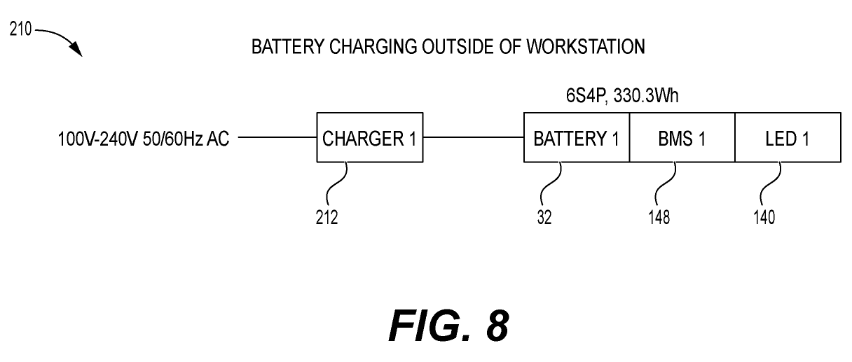

The system 10 may include one or more chargers 182, 184 configured to provide charge to the first and second batteries 32, 40 when power is provided to the system 10 from the external power source 136. The chargers 182, 184 may be any charger configured to provide power from the external power source 136 to the first and second batteries 32, 40. The chargers 182, 184 may be configured to convert the AC power from the external power source 136 to DC power for charging the first and second batteries 32, 40. In other embodiments, the power system 10 may omit the chargers 182, 184, such that the first and second batteries 32, 40 are removable for charging using an external charging system 200, such as the charging system illustrated in FIG. 8.

The first and second batteries 32, 40 may be electrically coupled in parallel and may be electronically coupled with a respective DC-DC converter 190, 192. For example, as shown in FIG. 7, the first battery 32 may be coupled with the first battery converter 190, and the second battery 40 may be coupled with the second battery converter 192. The DC‑DC converters 190, 192 may be configured to convert DC power from the respective batteries into DC power suitable for use by the controller 50, the display 160, one or more output ports 90, 92, and/or other electrically powered components of the cart 12, such as motors or actuators.

In some embodiments, the first and second batteries 32, 40 may be configured to selectively provide power to the inverter 164. The inverter 164 may convert DC power from the first and/or second batteries 32, 40 into AC power usable and transferable to devices via the power outlet output port 94. By way of example, the inverter 164 may be configured to provide one or more of a USB‑C power delivery output (e.g., up to 100 W), an AC power output (e.g., up to 300 W), and/or DC voltage outputs for powering onboard components of the cart 12, such as lift motors or wheel drives. The power system 10 may further include one or more USB‑A ports 90 and/or USB‑C ports 92 electrically coupled with and powered by the batteries 32, 40, with the ports optionally being communicatively coupled to the controller 50.

The cart 12 may further include one or more motor assemblies 196 configured to actuate various components of the cart 12. For example, the motor assemblies 196 may be configured to provide powered height adjustment, powered wheel movement, or other powered cart functions. Each motor assembly 196 may include a motor 198, a motor controller 200, and a motor driver 202. However, it is contemplated that the motor assemblies 196 may be controlled by the controller 50 (e.g., the motor assemblies 196 may not include a motor controller 200) without departing from the scope of the present disclosure. The system 10 is configured to provide power to the one or more motor assemblies 196.

The power system 10 may further include the controller 50 as described in more detail elsewhere herein. The controller 50 may be communicatively coupled with the battery management systems 148, 150, the display 160, the inverter 164, and one or more output ports, such as the USB‑C port 92. In various embodiments, the power system 10 may further include a DC‑DC converter 206 configured to convert power from the DC‑DC battery converters 190, 192 into voltage levels suitable for operation of the controller 50 and other low‑voltage control electronics.

Referring now to FIG. 8, an external charging system 210 is illustrated for charging one of the first or second batteries 32, 40 when the battery is removed from the cart 12. The external charging system 210 may include a charger 212 configured to be coupled with an external AC power source (not shown), such as a wall outlet or power distribution unit. The charger 212 may be configured to convert AC power received from the external AC power source into DC power suitable for charging and storage by the respective battery 32, 40. In some embodiments, the charger 212 may further include charge‑management and protection circuitry configured to regulate voltage, limit current, monitor temperature, and prevent over‑charging of the battery.

In various embodiments, the external charging system 210 may be provided as one of multiple external charging systems, which may be associated with the cart 12, stored separately from the cart, or deployed at a centralized charging location. The external charging system 210 may be configured to charge one battery at a time or, in other embodiments, may be configured to charge multiple batteries concurrently. The availability of the external charging system 210 may enable continued operation of the cart 12 by allowing depleted batteries to be removed and charged externally while one or more other batteries remain installed in the cart to provide power, thereby supporting uninterrupted operation and flexible battery management.

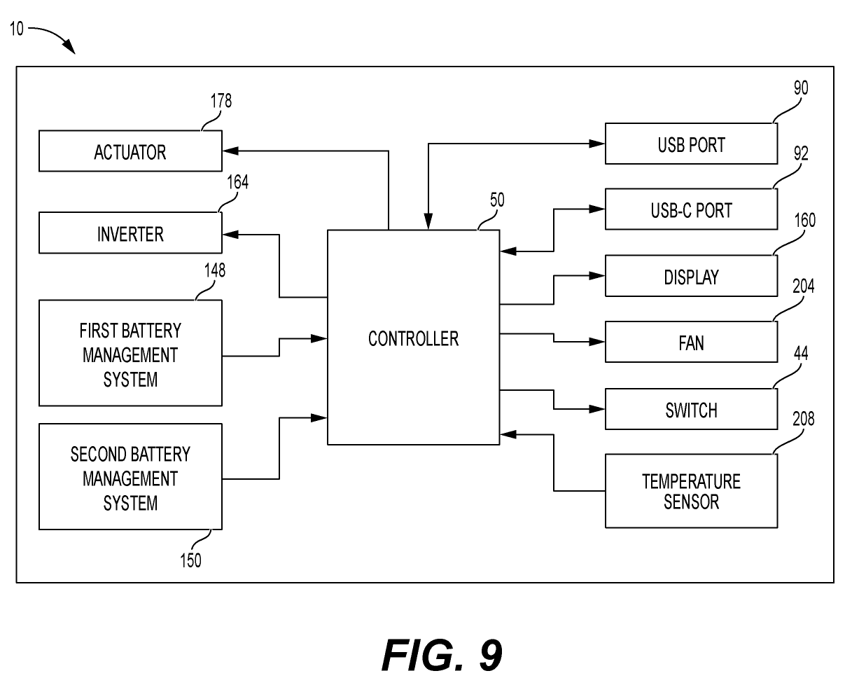

FIG. 9 is a block diagram of the power system 10 according to one embodiment of the present disclosure. As illustrated, the controller 50 may be communicatively coupled with the first and second battery management systems 148, 150 and may be configured to coordinate operation of the system 10 based on information received from the battery management systems. In particular, the controller 50 may be configured to determine which of the first and second batteries 32, 40 is actively supplying power to the system 10 and to control power switching therebetween to support continuous operation.

As further shown in FIG. 9, the first and second battery management systems 148, 150 may be in communication with the controller 50 and may be configured to monitor respective power levels of the first and second batteries 32, 40. For example, the first battery management system 148 may receive power‑level information from a first sensor 154 and communicate such information to the controller 50, while the second battery management system 150 may receive power‑level information from a second sensor 156 and communicate corresponding information to the controller 50. In operation, when the controller 50 determines that the power level of the first battery 32 exceeds a first power threshold, the controller 50 may communicate with the switch 44 to maintain the switch 44 in a first state, such that the system 10 draws power from the first battery 32. When the power level of the first battery 32 falls below the first power threshold, the controller 50 may command the switch 44 to transition to a second state, such that power is drawn from the second battery 40. The controller 50 may similarly monitor the power level of the second battery 40 and may initiate a transition back to the first battery 32 when the power level of the second battery 40 falls below a second power threshold. While power is not being drawn from a respective battery, that battery may be removed for replacement or charged either using an external charging system 210 or using a corresponding charger of the system 10. In this manner, the power system 10 may support hot‑swap battery replacement while maintaining uninterrupted power delivery to the cart 12.

In some embodiments, the power system 10 may include one or more fans 204 configured to provide active cooling for components of the system 10, such as the batteries, power converters, inverter, or controller. The one or more fans 204 may be communicatively coupled with and controlled by the controller 50, which may regulate fan operation based on system conditions. In other examples, the one or more fans 204 may be communicatively coupled with and controlled by a separate control system without departing from the scope of the present disclosure. In further embodiments, the system 10 may include one or more temperature sensors 208 for detecting when a portion of the system 10 needs to be cooled by a respective fan 204. The one or more temperature sensors may be communicatively coupled with and controllable by the controller 50. In other examples, the one or more temperature sensors may be communicatively coupled with and controlled by a separate control system.

The temperature sensors 208 may be configured to detect thermal conditions of one or more components of the system 10. The temperature sensors 208 may be configured to communicate temperature data to the controller 50, which may selectively activate or adjust operation of the one or more fans 204 when elevated temperatures are detected. In other examples, the temperature sensors 208 may be communicatively coupled with and controlled by a separate control system independent of the controller 50.

In some embodiments, the power system 10 may include a display 160 configured to present system information to a user. The display 160 may include an LCD display, an LED display, an OLED display, or any other suitable display device. In some embodiments, the display 160 may be positioned within the electronics housing 86 and operably coupled with one or more of the output ports 90, 92, 94. In various examples, power and data from the system 10 may be communicated to the display 160 via a USB‑C connection. For example, output and data may be provided through a USB‑C cable to the display 160. The display 160 may include an input USB‑C port configured to receive data for display and to deliver USB‑C power delivery (PD), such as up to 100 W. In some embodiments, the system 10 may further be configured to provide power through a USB‑A port at, for example, up to 18 W. This configuration may position USB power outputs proximate to a user to facilitate charging of devices such as tablets, mobile phones, or laptops.

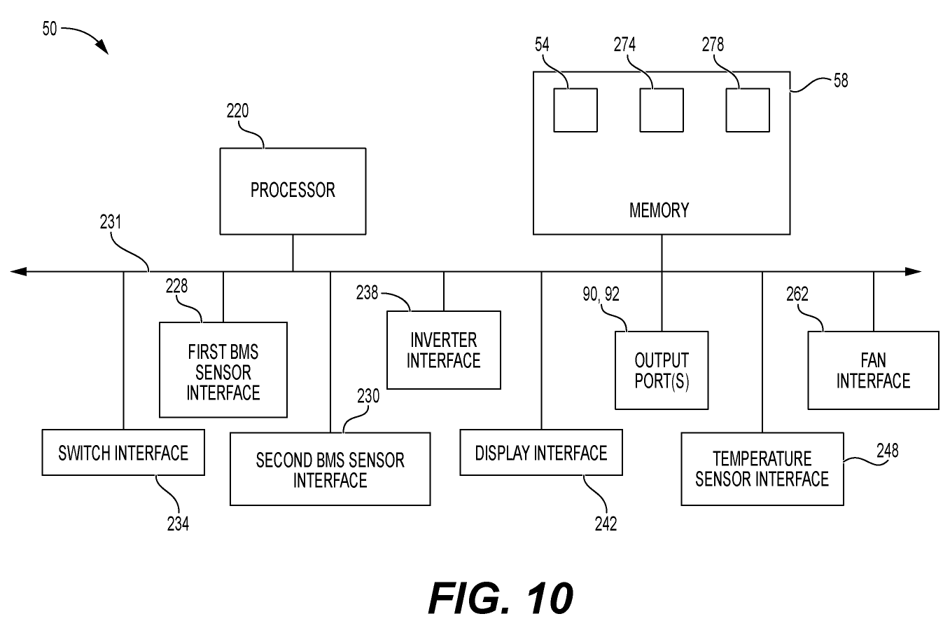

Referring now to FIG. 10, a block diagram of the controller 50 is shown according to one embodiment of the present disclosure. The controller 50 may be implemented as an electronic control device including hardware, software, and combinations thereof and may be configured to manage power delivery within the system 10. In particular, the controller 50 may be configured to determine power levels and operating conditions of the first and/or second batteries 32, 40 and adjust power draw from the first and/or second batteries 32, 40 via operation of the switch 44. In some embodiments, the controller 50 may include at least one processor 220, memory 58, a first battery management system interface 228, a second battery management system interface 230, a switch interface 234, an inverter interface 238, a display interface 242, one or more fan interfaces 262, and/or an actuator interface 266. The various interfaces may enable the controller 50 to receive data from, and transmit control signals to, corresponding system components.

The processor 220 may execute instructions stored in the memory 58 to interact with and control one or more components communicatively coupled to the controller 50. Although the processor 220 may communicate with other components of the controller 50 using any suitable communication mechanism, in various examples, the processor 220 may communicate with and drive the other components via a local interface 231. The local interface 231 may include one or more communication buses, such as a central processing unit (CPU) bus, a digital signal processor (DSP) bus, or other suitable data communication paths. The local interface 231 may further be communicatively coupled with the memory 58. During operation, the processor 220 may execute program instructions stored in the memory 58 and, based on those instructions, exchange data and control signals with the battery management system interfaces 228, 230, the switch interface 234, the inverter interface 238, the display interface 242, the fan interfaces 262, and the actuator interface 266 via the local interface 231 to coordinate overall system operation.

The memory 50 may be configured to store control logic 54, battery data 274 received from the first battery management system 148, battery data 278 received from the second battery management system 150, or other data provided by the components of the system 10 to the controller 50. Such data may be used by the controller 50 to determine whether to take actions regarding one or more of the components as described in more detail elsewhere herein. The memory 58 may include various tangible or non-transitory storage media. Examples of tangible (or non-transitory) storage medium include disks, thumb drives, and memory, etc., but does not include propagated signals. Tangible computer readable storage media may include volatile and non-volatile, removable and non-removable media, such as computer readable instructions, data structures, program modules or other data. Examples of such media include RAM, ROM, EPROM, EEPROM, SRAM, flash memory, disks or optical storage, magnetic storage, or any other non-transitory medium that stores information that is accessed by a processor or computing device.

The switch interface 234 may include software, hardware, or a combination of software and hardware configured to enable communicative coupling between the controller 50 and the switch 44. The switch 44 may include an electrical switching device configured to selectively couple one or both of the first and second batteries 32, 40 to the power system 10. In some embodiments, the switch 44 may support seamless transition between batteries under control of the controller 50 to support uninterrupted power delivery during battery replacement or variable loading conditions.

In some embodiments, the controller 50 may receive battery data 292 from the first and second battery management systems 148, 150. The first and second battery management systems 148, 150 may be integrally formed with the respective battery 32, 40 or may implemented as separate components from the batteries. Each battery management system 148, 150 may be communicatively coupled with the controller 50 via a respective battery management system interface 228, 230. The battery management system interfaces 228, 230 may each include software, hardware, or a combination thereof configured to support wired communication (e.g., Ethernet, USB, or serial communication) and/or wireless communication (e.g., Bluetooth®, Wi‑Fi®, or NFC). In some embodiments, the first and second battery management system interfaces 228, 230 may be implemented as a common interface without departing from the scope of the present disclosure.

As previously described, the first and second battery management systems 148, 150 may be configured to provide battery data 274, 278 either periodically or in response to requests from the controller 50. Such battery data 274, 278 may include information sufficient to allow the controller 50 to determine whether the switch 44 should be maintained in a first state or transitioned to a second state. For example, when battery data 274 indicates that a power level of the first battery 32 has fallen below a first power threshold, the controller 50 may command the switch 44 to transition from the first state to the second state such that the system 10 draws power from the second battery 40. Conversely, when battery data 274 indicates that the power level of the first battery 32 exceeds the first power threshold, and/or when battery data 278 indicates that the power level of the second battery 40 exceeds a second power threshold, the controller 50 may command the switch 44 to transition to or remain in the first state. In this manner, the controller 50 may dynamically manage battery selection to maintain system operation while enabling non‑active batteries to be replaced or charged either using an external charging system 210 or an onboard charger of the system 10.

In one embodiment, the controller 50 may include the inverter interface 238. The inverter interface 238 may include software, hardware, or any combination of hardware and software for coupling the controller 50 communicatively with the inverter 164. The inverter interface 238 may be configured for wired (ethernet, USB, etc.) or wireless (Bluetooth, WiFi, NFC, etc.) communication and may include a plurality of physical interfaces in various examples.

With continued reference to FIG. 10, the controller 50 may be configured to be in communication with one or more temperature sensors 208 via the temperature sensor interface 248. The temperature sensor interface 248 may include software, hardware, or any combination of hardware and software for coupling the controller 50 communicatively with the temperature sensors 208. The temperature sensor interface 248 may be configured for wired (ethernet, USB, etc.) or wireless (Bluetooth, WiFi, NFC, etc.) communication and may include a plurality of physical interfaces in various examples. The controller 50 may also be configured to communicate with the one or more fans 204 via a fan interface 262. The fan interface 262 may include software, hardware, or any combination of hardware and software for coupling the controller 50 communicatively with the fan(s) 204. The fan interface 262 may be configured for wired (ethernet, USB, etc.) or wireless (Bluetooth, WiFi, NFC, etc.) communication and may include a plurality of physical interfaces in various examples. The controller 50 may be configured to communicate with the fan(s) 204 via the fan interface 262 in response to indications from the temperature sensors 248.

The controller 50 may further be in communication with the display 160 and configured to selectively control operation of the display 160 to present information relating to the first and second batteries 32, 40. By way of example, the display 160 may be configured to present one or more battery‑related properties, including but not limited to battery power level, input power and output power associated with each battery, estimated time remaining until a battery reaches a fully charged state, estimated time remaining until a battery falls below a predetermined power threshold, or estimated time remaining until a battery reaches a depleted condition. In some embodiments, the display 160 may further be configured to indicate which battery is actively supplying power to the system and whether a battery is available for removal during hot‑swap operation. Additionally, the display 160 may be configured to present other system information not directly related to the batteries, such as time, system status, alerts, or operational messages.

The controller 50 may communicate with the display 160 via a display interface 242, which may include software, hardware, or a combination of hardware and software configured to enable communicative coupling between the controller 50 and the display 160. In various embodiments, the display interface 242 may support wired communication, such as Ethernet or USB, and/or wireless communication, such as Bluetooth®, Wi‑Fi®, or near‑field communication (NFC). The display interface 242 may further include one or more physical interfaces and communication protocols, thereby enabling flexible placement and integration of the display 160 within the cart 12.

The memory 58 may include one or more memories configured to store control logic 54. The control logic 54 includes instructions for generally controlling the operation of the controller 50 and its various resources to perform actions to carry out essentially any function ascribed herein to the system 10, and thus actions attributed to the system 10 may be based on execution by the processor 220 of instruction stored in the logic 54. It should be noted that the control logic 54 may be implemented in software, hardware, firmware, or any combination thereof. Note also that the control logic 54, when implemented in software, can be stored and transported on any computer-readable medium for use by or in connection with an instruction execution apparatus that can fetch and execute instructions. In the context of this document, a “computer-readable medium” can be any means that can contain or store a program for use by or in connection with an instruction execution apparatus.

In some embodiments, the control logic 54 may include instructions that cause the controller 50 to determine the power levels of each of the first and second batteries 32, 40. When the controller 50 determines that the power level of the first battery 32 is above a first power threshold, the control logic 54 may include instructions to cause the controller 50 to communicate with the switch 44 to draw power from the first battery 32. When the controller 50 determines that the power level of the first battery 32 is below the first power threshold and that the power level of the second battery 40 is above a second power threshold, the control logic 54 may include instructions to cause the controller 50 to communicate with the switch 44 to draw power from the second battery 40. When the controller 50 determines that the power level of the first battery 32 is above the first power threshold, the control logic 54 may include instructions to cause the controller to communicate with the switch 44 to stop drawing power from the second battery 40 and resume drawing power from the first battery 32.

With continued reference to FIGS. 7, 9, and 10, in operation, the controller 50 may be configured to operate the system 10 to cause various actions, as previously described. In operation, the controller 50 is configured to determine if power should be drawn from the first battery 32 or from the second battery 40. In other words, the controller 50 is configured to the place the switch 44 in the first state when the controller 50 determines that power should be drawn from the first battery 32 and to place the switch 44 in the second state when the controller 50 determines that power should be drawn from the second batter 40.

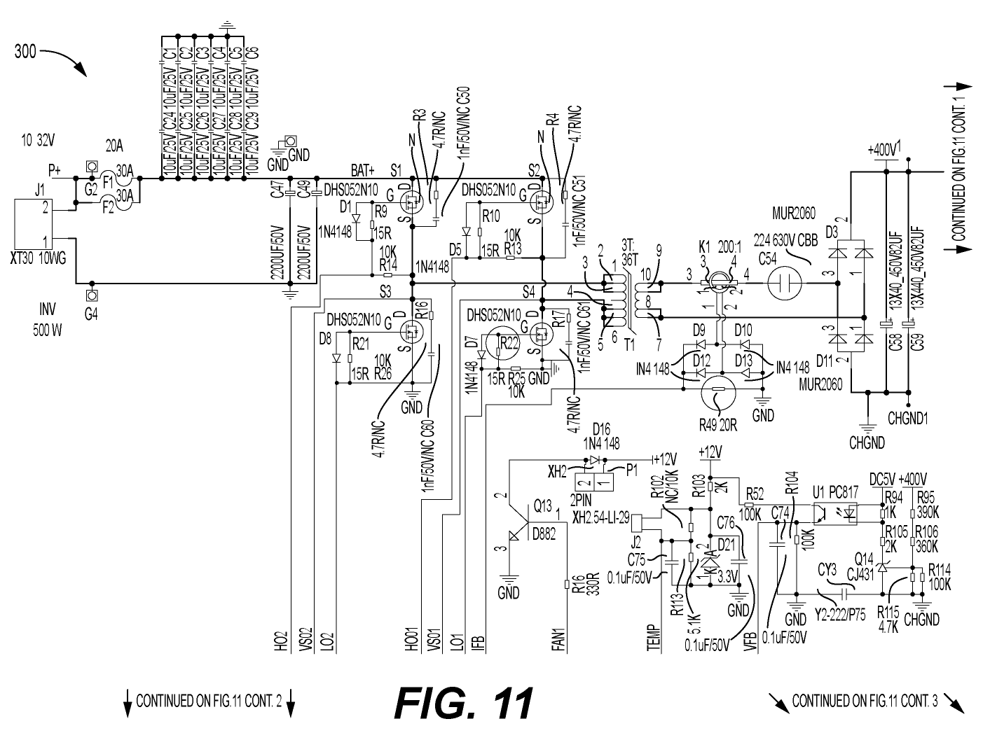

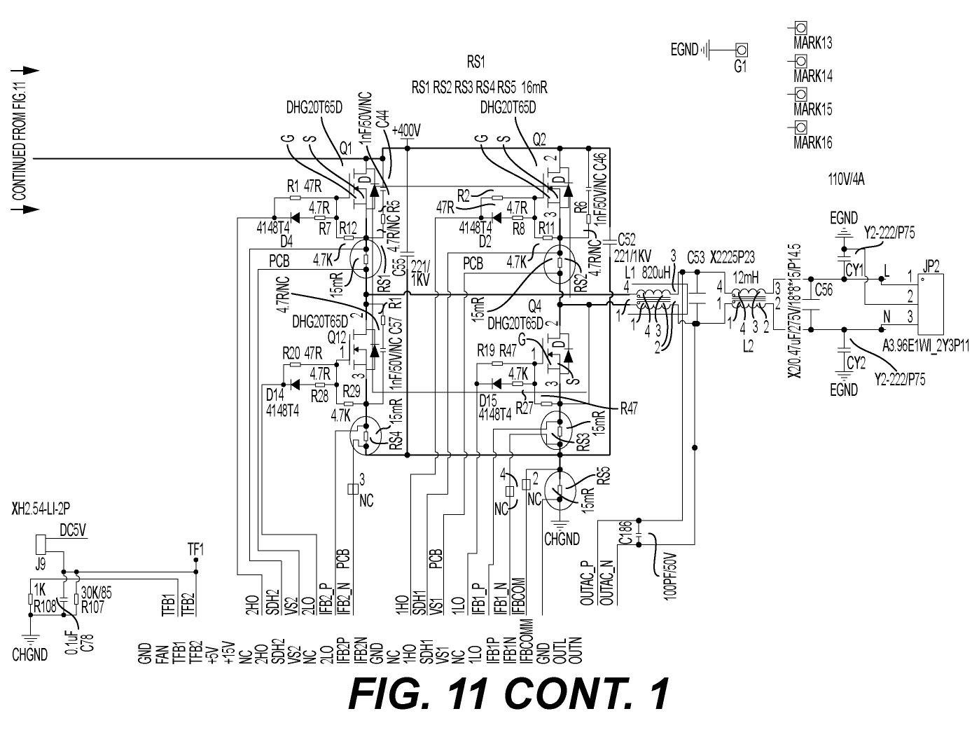

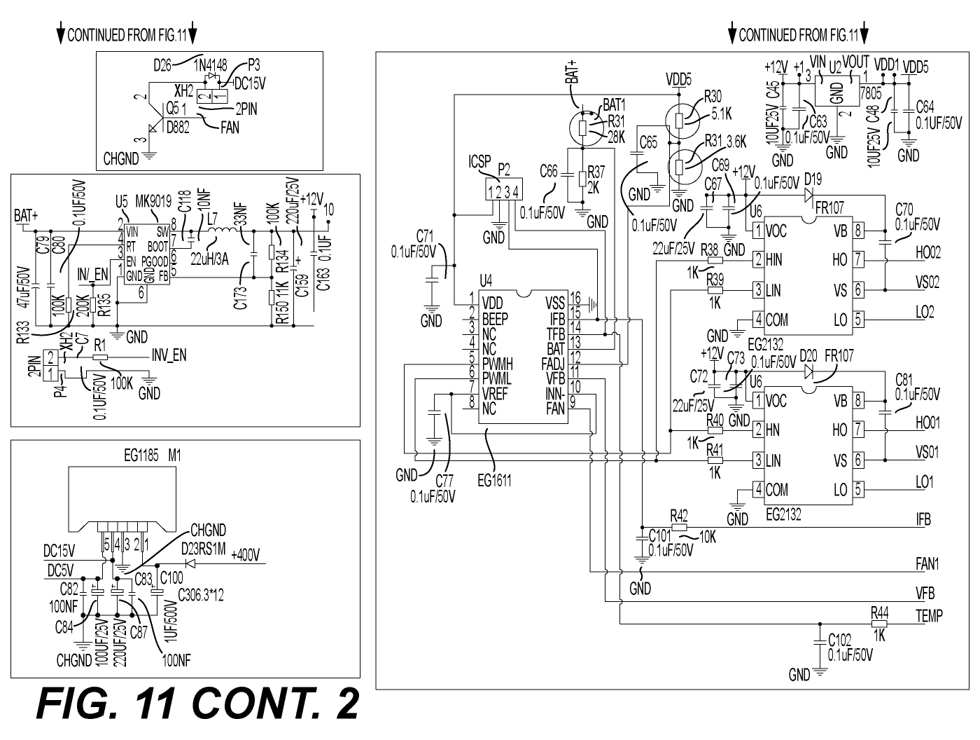

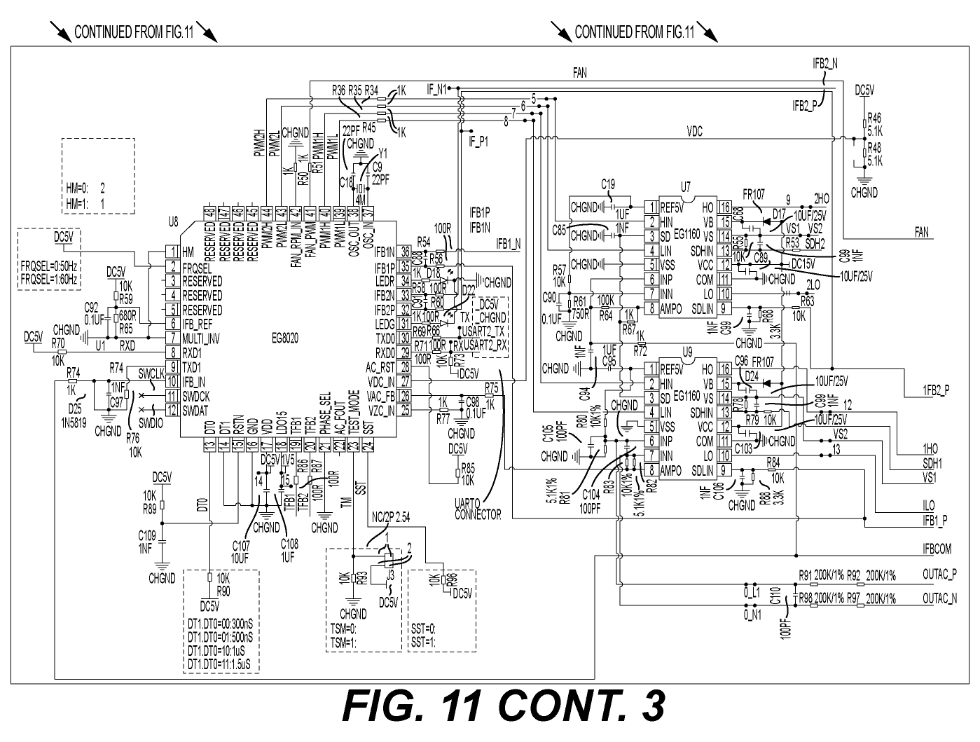

FIG. 11 is a schematic diagram of an inverter enable (EN) control circuit 300 for the power system 10 according to one example of the present disclosure. The EN control circuit 300 is operably coupled with the inverter 164 and is configured to selectively control activation of the inverter in coordination with the controller 50 and the power‑management architecture described above with reference to FIGS. 7 and 9–10. In the illustrated embodiment, the EN control circuit 300 implements an inverted enable logic, where a logic‑high signal corresponds to an enabled or ON state of the inverter 164 and a logic‑low signal corresponds to a disabled or OFF state. As a result, the inverter 164 remains disabled by default upon initial coupling of a power source, such as insertion of a battery or connection of an external power source and is not activated until an affirmative enable signal is provided. By requiring the EN control pin to receive a logic‑high signal before energizing the inverter 164, the power system 10 may delay inverter startup until conditions determined by the controller 50 are satisfied, such as stabilization of battery voltage, confirmation of proper battery engagement, selection of an active battery by the switch 44, or completion of other startup or safety checks. In this manner, the EN control circuit may limit inrush current and mitigate sparking or arcing that could otherwise occur due to a sudden surge of current during inverter activation.

In some embodiments, the EN control circuit of FIG. 11 may be implemented on a UPS board or other power‑conditioning circuitry associated with the inverter 164 and may operate in conjunction with control logic stored in the memory 58 and executed by the processor 220 of the controller 50. The controller 50 may selectively enable signal based on the battery data received from the first and second battery management systems 148, 150, operational state of the system 10, or user input received via the actuator 178. The inverted EN control logic therefore complements the dual‑battery, hot‑swappable architecture described herein by providing controlled and predictable inverter engagement, improving reliability, reducing electrical stress on system components, and supporting uninterrupted operation of the cart 12 during battery insertion, removal, or transition between power sources.

It will be understood by one having ordinary skill in the art that construction of the described concepts, and other components, is not limited to any specific material. Other exemplary embodiments of the concepts disclosed herein may be formed from a wide variety of materials unless described otherwise herein.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A mobile power system, comprising:
a movable cart having a base;
a first battery and a second battery removably coupled to the base;
a first battery management system configured to monitor a power level of the first battery and a second battery management system configured to monitor a power level of the second battery;
a controller in communication with the first battery management system and the second battery management system and configured to receive the power levels therefrom;
a switch operable by the controller to selectively couple at least one of the first battery or the second battery to a power bus; and
wherein, based at least in part on the power levels received from the first and second battery management systems, the controller is configured to control which of the first and second batteries supplies power to the power bus and to enable uninterrupted operation of the mobile power system during removal or replacement of one of the batteries.

2. The mobile power system of claim 1, wherein the controller is configured to cause the switch to transition power draw from the first battery to the second battery when the power level of the first battery falls below a first threshold.

3. The mobile power system of claim 1, further comprising a DC-DC converter coupled between each of the first battery and the second battery and the power bus.

4. The mobile power system of claim 1, further comprising an inverter coupled to the power bus, wherein the inverter is configured to provide AC power to at least one output port.

5. The mobile power system of claim 1, further comprising an external power source connector configured to receive power from an external AC source.

6. The mobile power system of claim 5, further comprising at least one charger configured to charge at least one of the first or second batteries while the system is powered by the external AC source.

7. The mobile power system of claim 1, wherein each of the first battery and the second battery comprises an indicator configured to display at least one of charge state, charging status, or fault status.

8. The mobile power system of claim 1, further comprising a display operatively connected to the controller and configured to display battery status information.

9. A mobile power system, comprising:
a movable cart having a base;
a battery housing attached to the base and defining a first receiving space and a second receiving space;
a first connector configured to be coupled with a first battery positioned within the first receiving space;
a second connector configured to be coupled with a second battery positioned within the second receiving space;
a switch operatively connected to the first connector and the second connector;
a controller configured to be communicatively coupled with the switch, the controller comprising instructions stored in memory which, when executed by the controller, cause the controller to:
communicate with the switch to draw power from the first battery via the first connector;
determine whether a power level of the first battery is below a predetermined power level; and
communicate with the switch to draw power from the second battery in response to determining that the power level of the first battery is below the predetermined power level.

10. The mobile power system of claim 9, wherein the instructions, when executed by the controller, cause the controller to:
communicate with the switch to stop drawing power from the first battery in response to determining that the power level of the first battery is below the predetermined power level.

11. The mobile power system of claim 9, wherein the instructions, when executed by the controller, cause the controller to:
determine whether a power level of the second battery is below a predetermined power level; and
communicate with the switch to draw power from the first battery in response to determining that the power level of the second battery is below the predetermined power level.

12. The mobile power system of claim 11, wherein the instructions, when executed by the controller, cause the controller to:
communicate with the switch to stop drawing power from the second battery in response to determining that the power level of the second battery is below the predetermined power level.

13. The mobile power system of claim 9, wherein the battery housing is positioned such that a center of gravity of the movable cart is proximate the base of the cart.

14. The mobile power system of claim 9, wherein the battery housing comprises a first retention clip configured to retain the first battery within the battery housing during operation and a second retention clip configured to retain the second battery within the battery housing during operation.

15. The mobile power system of claim 14, wherein each of the first retention clip and the second retention clip comprises one or more protrusions configured to align with and be received by corresponding slots formed in each of the first and second receiving spaces.

16. A method of providing uninterrupted power to a mobile workstation comprising a first battery and a second battery, a controller in communication with the first battery and the second battery, and a switch operable by the controller to selectively couple at least one of the first battery or the second battery to a power bus, the method comprising:
monitoring, by the controller, power data from the first battery and the second battery; supplying power from the first battery to the power bus;
detecting that the power level of the first battery falls below a threshold;
automatically switching, via the switch, power from the first battery to the second battery; and maintaining power to the mobile workstation during the switching.

17. The method of claim 16, further comprising removing the first battery from the mobile workstation while the second battery supplies power.

18. The method of claim 16, further comprising charging one of the batteries using an external charging system while the other battery remains installed.

19. The method of claim 16, further comprising displaying battery status information on a display coupled to the mobile workstation.

20. The method of claim 19, wherein the battery status information comprises at least one of voltage, current, temperature, state of charge, or state of health.
